(19) United States
(12) Patent Application Publication
(10) Pub. No.: US 2026/0277510 A1
(43) Pub. Date: Sep. 17, 2026

(54) IMAGE FORMING SYSTEM AND CONTROL METHOD FOR IMAGE FORMING SYSTEM

(71) Applicant: SEIKO EPSON CORPORATION, Tokyo (JP)

(72) Inventor: Satoshi AIBA, SHIOJIRI-SHI (JP)

(21) Appl. No.: 19/563,333

(22) Filed: Mar. 11, 2026

(30) Foreign Application Priority Data
Mar. 12, 2025 (JP) 2025-039107

(51) Int. Cl. G06F 3/12

(52) U.S. Cl. CPC G06F 3/1229; G06F 3/1204; G06F 3/1221; G06F 3/1239; G06F 3/1254; G06F 3/1255; G06F 3/1273

(57) ABSTRACT

An image forming system includes a print head, a medium transport section, a display section that displays information, and a control section, wherein the control section calculates a printable number of sheets of a medium based on power supply information including information that indicates a capacitance of a power supply and displays, on the display section, the printable number of sheets.

The present application is based on, and claims priority from JP Application Serial Number 2025-039107, filed Mar. 12, 2025, the disclosure of which is hereby incorporated by reference herein in its entirety.

### BACKGROUND

### 1. Technical Field

The present disclosure relates to an image forming system and a control method for the image forming system.

### 2. Related Art

An image forming system disclosed in JP-A-2023-30667 includes an image forming device. The image forming device has an operation mode for when connecting to a commercial power supply connection time operation mode and an operation mode for when connecting to an individual power supply connection time operation mode. The commercial power supply connection time operation mode is a mode in which the image forming device is operated by the electric power supplied from a commercial power supply. The individual power supply connection time operation mode is a mode in which the image forming device is operated by power supplied from an individual power supply. The individual power supply is, for example, an uninterruptible power supply or a portable power supply.

The capacitance of an individual power supply such as an uninterruptible power supply or a portable power supply decreases with use. Therefore, sometimes the job instructed by the user may not be completed.

### SUMMARY

An image forming system that solves the above problem is an image forming system that operates by power supplied from power supply and that includes a print head configured to print on a medium; a medium transport section configured to transport the medium toward the print head; a display section configured to display information related to printing; a control section configured to control the display section, wherein the control section calculates a printable number of sheets of the medium that are printable by the print head based on power supply information, which is information of the power supply and which includes at least information indicating capacitance of the power supply and

displays, on the display section, the printable number of sheets.

A control method of an image forming system operated by power supplied from a power supply, the image forming system including a print head configured to perform printing on a medium and a display section configured to display information related to printing, the control method including acquiring power supply information including information that indicates a capacitance of the power supply; calculating, based on the power supply information, a printable number of sheets, which is a number of sheets of the medium on which printing by the print head is possible; and displaying, on the display section, the printable number of sheets.

### BRIEF DESCRIPTION OF THE DRAWINGS

FIG. 1 is a perspective view illustrating an example of an image forming system.

FIG. 2 is a schematic configuration diagram of the image forming system.

FIG. 3 is a flowchart illustrating a print control according to the first embodiment.

FIG. 4 is a diagram illustrating an example of a power supply information input screen.

FIG. 5 is a diagram illustrating an example of a printable sheet number display screen.

FIG. 6 is a diagram illustrating an example of a function selection screen.

FIG. 7 is a flowchart illustrating an update control.

FIG. 8 is a flowchart illustrating a print control according to a second embodiment.

FIG. 9 is a diagram illustrating an example of a print mode selection screen.

FIG. 10 is a flowchart illustrating a print control according to the third embodiment.

FIG. 11 is a diagram illustrating an example of a setting screen.

FIG. 12 is a diagram illustrating an example of the setting screen.

FIG. 13 is a diagram illustrating an example of the setting screen.

### DESCRIPTION OF EMBODIMENTS

### First Embodiment

A first embodiment of the image forming system will be described.

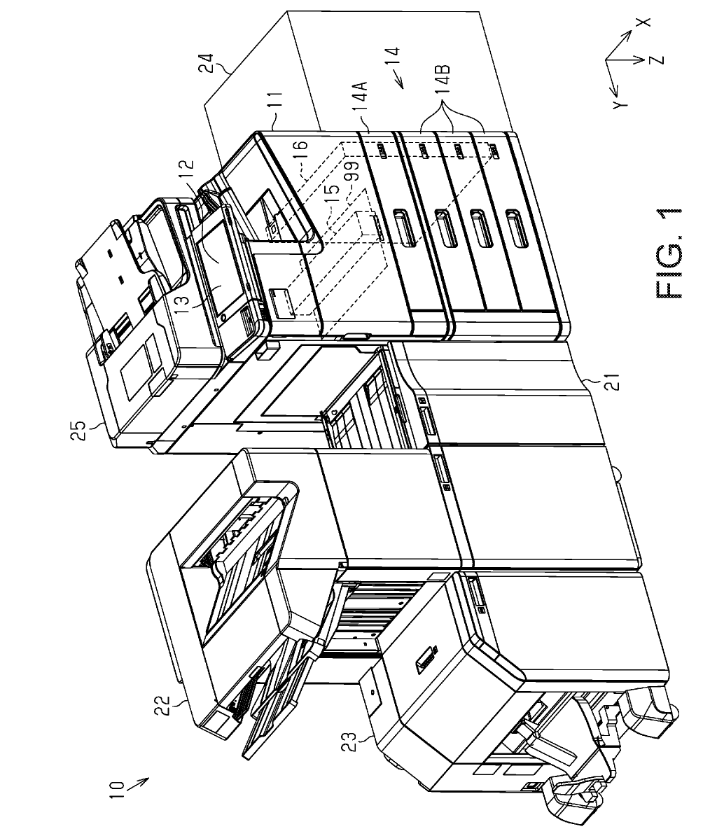

As illustrated in FIG. 1, the image forming system 10 includes an image forming device 11, an intermediate device 21, a post-process device 22, and a center folding device 23. The image forming system 10 is placed on a horizontal plane. The direction of gravity is indicated by a Z-axis, and the directions along the horizontal plane are indicated by a X-axis and a Y-axis. The X-axis, the Y-axis, and the Z-axis are orthogonal to each other. In the following description, a direction parallel to the X-axis is also referred to as a width direction X, a direction parallel to the Y-axis is also referred to as a transport direction Y, and a direction parallel to the Z-axis is also referred to as a vertical direction Z.

The image forming device 11 is, for example, an inkjet type printer that forms an image by ejecting ink, which is an example of a liquid, onto a medium 99. The image is formed by the liquid that adheres to the medium 99. The image includes at least one of a photograph, a pattern, a character, a symbol, a mark, a line, and a table.

The image forming device 11 includes a display section 12 configured to display information related to printing.

The image forming device 11 may include an input section 13. The input section 13 receives input from a user. The input section 13 is, for example, a touch panel. The input section 13 may be a physical button. When the input section 13 is a touch panel, the input section 13 is provided integrally with the display section 12.

The image forming device 11 includes a medium accommodating section 14. The medium accommodating section 14 is configured to accommodate the medium 99 in a stacked state. The medium accommodating section 14 includes a built-in cassette 14A. The medium accommodating section 14 may include at least one additional cassette 14B. The additional cassette 14B is, for example, a cassette that is added as an option.

The image forming device 11 includes a print head 15 that performs printing on the medium 99. The print head 15 performs, for example, printing on the medium 99 by ejecting liquid from the nozzles. An image is formed on the medium 99 by printing on the medium 99 using the print head 15. The print head 15 forms an image on the medium 99 fed one sheet at a time from the medium accommodating section 14. The print head 15 of the present embodiment is a line type provided over the width direction X of the medium 99. The print head 15 may be a serial type that forms an image while moving in the width direction X of the medium 99.

The image forming device 11 includes a medium transport section 16. The medium transport section 16 includes, for example, a guide member that guides the medium 99, a roller, and a motor that rotates the roller.

The medium transport section 16 transports, for example, the medium 99 accommodated in the medium accommodating section 14 toward the print head 15. The medium transport section 16 may include a first transport path that transports the medium 99 from the built-in cassette 14A to the print head 15, and a second transport path that transports the medium 99 from the additional cassette 14B to the first transport path. A direction in which the medium 99 is transported from the medium transport section 16 toward the print head 15 is a transport direction Y.

The image forming device 11 is configured to perform single-sided image formation in which an image is formed on only one surface of the medium 99, and double-sided image formation in which an image is formed on both surfaces of the medium 99. In the case of performing single-sided image formation, the image forming device 11 forms an image on the front side of the medium 99 and then sends the medium 99 to the intermediate device 21. In the case of performing double-sided image formation, the image forming device 11 forms an image on the front surface of the medium 99, then reverses the medium 99 and returns the medium 99 to the print head 15, and forms an image on the back surface of the medium 99. The image forming device 11 sends the medium 99 on which images are formed on both sides to the intermediate device 21.

The intermediate device 21 is adjacent to the image forming device 11 in the transport direction Y. The intermediate device 21 sends the medium 99 on which an image is formed on one side or both sides to the post process device 22. In a case where the medium 99 on which an image is formed is subjected to a center folding process of the medium 99, the post process device 22 sends the medium 99 to the center folding device 23. The center folding device 23 may perform a saddle stitching process on the medium 99 to stitch the center of the medium 99 with a staple. In this manner, the center folding device 23 performs processes such as a center folding process or a saddle stitching process on the medium 99 on which printing was performed, that is, the medium 99 on which an image was formed.

The post process device 22 is adjacent to the intermediate device 21 in the transport direction Y. The post-process device 22 performs processes on the medium 99 on which printing was performed, that is, the medium 99 on which an image was formed. The processes performed on the medium 99 by the post-process device 22 are referred to as post processing. The post processing includes at least one of an alignment process, a staple process, a punch process, and a shift process. The alignment process is a process of aligning the sides of the medium 99 in a state where plural sheets of the medium 99 are bundled. The staple process is a process of binding plural sheets of the medium 99 with staples. The punch process is a process of punching a hole in one or plural sheets of the medium 99. The shift process discharges the medium 99 in sets while shifting the position of the medium 99 for each set. The post-process device 22 is an example of a processing section.

The post-process device 22 is not limited to a floor standing type. Instead of the floor standing type post-process device 22, a functional unit for post process may be incorporated into the image forming device 11. The floor standing type post-process device 22 is also called a floor finisher. The post process function built into the image forming device 11 is also called an inner finisher.

The image forming system 10 may include a large capacity sheet feeding device 24. The large capacity sheet feeding device 24 is used in combination with the image forming device 11. The large capacity sheet feeding device 24 is adjacent to the image forming device 11 in the transport direction Y. The large capacity sheet feeding device 24 is provided on the opposite side of the image forming device 11 from the intermediate device 21. The large capacity sheet feeding device 24 accommodates one or more sheets of the medium 99. The maximum sheet accommodation number of the medium 99 that can be accommodated in the large capacity sheet feeding device 24 is larger than the maximum sheet accommodation number of the medium 99 that can be accommodated in the built-in cassette 14A. The large capacity sheet feeding device 24 supplies the accommodated medium 99 to the medium transport section 16. The large capacity sheet feeding device 24 is an example of a medium supply device.

The image forming system 10 may include an image reading device 25. The image reading device 25 is adjacent to the image forming device 11 in the vertical direction Z. Specifically, the image reading device 25 is provided in an upper portion of the image forming device 11. The image reading device 25 reads a document as an image. The image reading device 25 generates read data that indicates an image read from a document.

The image reading device 25 may be configured to read one side of the document or may be configured to read both sides of the document. The image reading device 25 may be configured to read a document in full color or may be configured to read a document in grayscale.

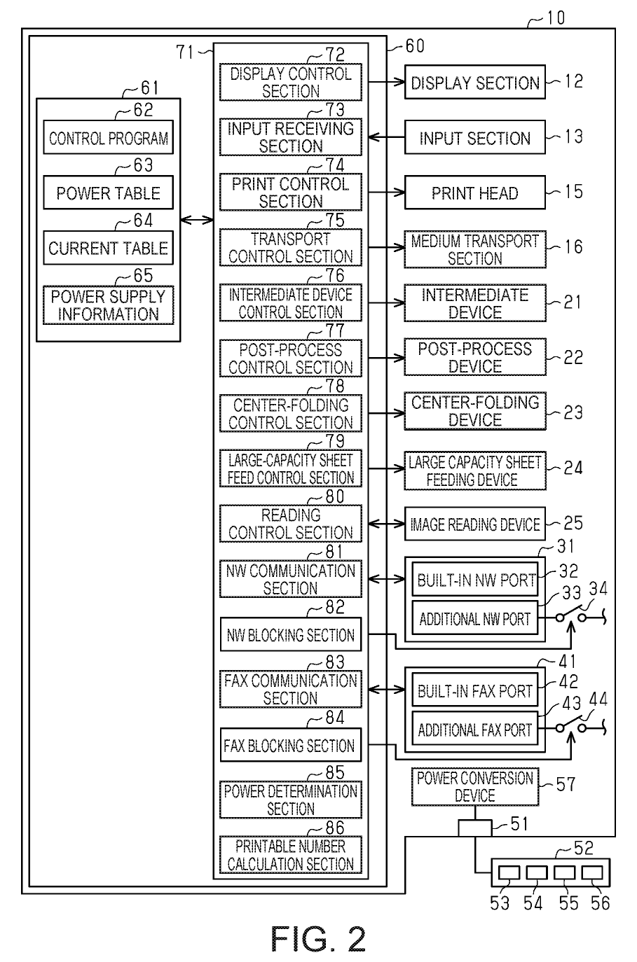

As illustrated in FIG. 2, the image forming system 10 may include a network port 31. A network cable is connected to the network port 31. By this, the image forming system 10 is connected to the external device via the communication network. The external device is, for example, a computer that transmits an instruction to the image forming system 10. The network port 31 includes a built-in network port 32. The network port 31 may include an additional network port 33. The additional network port 33 is, for example, a network port added as an option.

The image forming system 10 may include a FAX port 41. A telephone line cable is connected to the FAX port 41. This enables the image forming system 10 to perform facsimile communication via the public line. The facsimile communication is an operation that transmits the read data to a designated transmission destination. The transmission destination is, for example, another facsimile device. The FAX port 41 includes a built-in FAX port 42. The FAX port 41 may include an additional FAX port 43. The additional FAX port 43 is, for example, a FAX port that is extended as an option.

The image forming system 10 includes a connection section 51. The connection section 51 is, for example, a plug connected to the power supply 52. When the connection section 51 is connected to the power supply 52, power is supplied from the power supply 52 to the image forming system 10. The image forming system 10 operates with power supplied from a power supply 52. The connection section 51 is configured to be connected to a commercial power supply or a portable power supply such as the power supply 52.

The power supply 52 of the present embodiment is the portable power supply. The power supply 52 includes a rechargeable secondary battery 53 and a DC/AC conversion section 54 that converts DC power output from the secondary battery 53 into AC power and outputs the AC power. The power supply 52 outputs power by discharging of the secondary battery 53. That is, the capacitance of the power supply 52 decreases as the power supply 52 is used. The power supply 52 may include a battery management system 55. The battery management system 55 detects the state of the secondary battery 53. The state of the secondary battery 53 includes a charging rate of the secondary battery 53. The power supply 52 may include a display device 56. The display device 56 displays the state of the secondary battery 53. For example, the display device 56 displays the charging rate of the secondary battery 53. The power supply 52 may be an uninterruptible power supply.

The image forming system 10 includes a power conversion device 57. Power is supplied to the power conversion device 57 from the power supply 52 connected to the connection section 51. The power conversion device 57 performs power conversion of the power supplied from the power supply 52. The power conversion device 57 includes an AC/DC conversion section that converts AC power into DC power and outputs the DC power. The power conversion device 57 outputs the converted power to the power supply target. The power supply target includes the display section 12, the input section 13, the print head 15, the medium transport section 16, the intermediate device 21, the post-process device 22, the center folding device 23, the large capacity sheet feeding device 24, the image reading device 25, the network port 31, and the FAX port 41.

The image forming system 10 may include a network port switch 34. The network port switch 34 switches between supplying and shutting off power to the additional network port 33. The network port switch 34 is provided, for example, on a power supply line that supplies power output from the power conversion device 57 to the additional network port 33. When the network port switch 34 is closed, the additional network port 33 and the power conversion device 57 are electrically connected to each other. By this, power is supplied to the additional network port 33. When the network port switch 34 is opened, the additional network port 33 and the power conversion device 57 are electrically insulated from each other. By this, the power to the additional network port 33 is cut off.

The image forming system 10 may include a FAX port switch 44. The FAX port switch 44 switches between supply and interruption of power to the additional FAX port 43. The FAX port switch 44 is provided, for example, on a power supply line that supplies power output from the power conversion device 57 to the additional FAX port 43. When the FAX port switch 44 is closed, the additional FAX port 43 and the power conversion device 57 are electrically connected to each other. By this, power is supplied to the additional FAX port 43. When the FAX port switch 44 is opened, the additional FAX port 43 and the power conversion device 57 are electrically insulated from each other. By this, the power to the additional FAX port 43 is cut off.

The image forming system 10 includes a control section 60. The control section 60 may be configured by one or more processors that execute various processes according to a computer program. The control section 60 may be configured by one or more dedicated hardware circuits, for example, ASICs, that execute at least a part of the various processes. The control section 60 may be configured by a circuit including a combination of a processor and a hardware circuit. The processor includes a CPU and a memory 61 such as a RAM and a ROM. The memory 61 stores program codes or instructions configured to cause the CPU to execute processing. The memory, that is, a computer readable medium, includes any readable medium that can be accessed by a general purpose or dedicated computer.

The memory 61 stores a control program 62. The control program 62 is a program executed by the control section 60.

The memory 61 stores a power table 63. The power table 63 is a table in which an electric device that operates by consuming power is associated with a power value (W) required for the operation of the electric device. The power value required for the operation of the electric device is a power value required for the electric device to perform one process or a power value required per unit time for the electric device to operate. The electric device includes, for example, the print head 15, the medium transport section 16, the intermediate device 21, the post-process device 22, the center folding device 23, the large capacity sheet feeding device 24, the image reading device 25, the network port 31, and the FAX port 41. The power table 63 may associate each of the print head 15, the medium transport section 16, the intermediate device 21, the post- process device 22, the center folding device 23, the large capacity sheet feeding device 24, the image reading device 25, the network port 31, and the FAX port 41 with a power value required for an operation.

The power value required for the operation of the medium transport section 16 differs depending on whether the function of the additional cassette 14B is enabled or disabled. By this, in the power table 63, different power values may be associated with a case where the function of the additional cassette 14B is enabled and a case where the function of the additional cassette 14B is disabled.

The power value required for the operation of the post-process device 22 is a power value required for the operation of the floor finisher. The power table 63 may include a power value required for the operation of the inner finisher. This allows the power table 63 to be used also in an image forming system including an inner finisher. That is, the power table 63 may be used for general purposes in different types of image forming systems.

The power value required for the operation of the network port 31 differs depending on whether the function of the additional network port 33 is enabled or disabled. By this, in the power table 63, different power values may be associated with a case where the function of the additional network port 33 is enabled and a case where the function of the additional network port 33 is disabled.

The power value required for the operation of the FAX port 41 differs depending on whether the function of the additional FAX port 43 is enabled or disabled. Therefore, the power table 63 may associate different power values with the case where the function of the additional FAX port 43 is enabled and the case where the function of the additional FAX port 43 is disabled.

The power table 63 may associate the electric device with the power value required for the operation of the electric device in correspondence with a plurality of print modes. The print modes may include a mode that performs color printing, a mode for performing monochrome printing, a mode with a different resolution, and a mode with a different size of the medium 99. The power value required for the operation of the electric device is different between color printing and monochrome printing. The power value required for the operation of the electric device also varies depending on the size of the medium 99.

Therefore, when the image forming system 10 has a plurality of print modes, the power table 63 may associate the power value required for the operation of the electric device with the print modes.

The power table 63 may associate the electric device with the power value required for the operation of the electric device in correspondence with each of printing by the copy function and printing by the print function. The copy function is a function that prints an image read by the image reading device 25 on the medium 99. The printing function is a function that performs printing on the medium 99 using image data acquired from a computer via a communication network or image data acquired from a storage medium that is attachable to and detachable from the image forming system 10. The copy function and the print function require different power values for the operation of the electric device. Therefore, the power table 63 may be a table in which the power values required for the operation of the electric device are associated with the copy function and the print function.

The memory 61 may store a current table 64. The current table 64 is a table in which the electric device is associated with a current value (A) required for the operation of the electric device. The current value required for the operation of the electric device is a current value required for the electric device to perform one process or a current value required per unit time for the electric device to operate.

In the current table 64, different current values may be associated with a case where the function of the additional cassette 14B is enabled and a case where the function of the additional cassette 14B is disabled. The current table 64 may include a current value required for the operation of the inner finisher. In the current table 64, different current values may be associated with a case where the function of the additional network port 33 is enabled and a case where the function of the additional network port 33 is disabled. The current table 64 may associate different current values with a case where the function of the additional FAX port 43 is enabled and a case where the function of the additional FAX port 43 is disabled. The current table 64 may be a table in which the electric device and the current value required for the operation of the electric device are associated with each other in correspondence with a plurality of print modes. The current table 64 may associate the electric device with the current value required for the operation of the electric device in correspondence with each of printing by the copy function and printing by the print function.

The memory 61 stores power supply information 65. The power supply information 65 is information on the power supply 52. The information on the power supply 52 includes at least information that indicates the capacitance (Wh) of the power supply 52. The capacitance of the power supply 52 is the remaining capacitance of the power supply 52, that is, the remaining capacitance of the secondary battery 53. The information that indicates the capacitance of the power supply 52 may be information on the capacitance of the power supply 52 itself or information from which the capacitance of the power supply 52 can be calculated. The information that enables calculation of the capacitance of the power supply 52 is, for example, information that indicates the rated capacity of the power supply 52 and information that indicates the charging rate of the power supply 52.

The power supply information 65 may include information that indicates the specification of the power supply 52. The information that indicates the specification of the power supply 52 may include information that indicates the rated capacity of the power supply 52 and information that indicates the maximum output current of the power supply 52.

The control section 60 includes a control unit 71. The control unit 71 is configured by software configured by the computer of the control section 60 that executes the control program 62 and the like, and hardware such as an ASIC.

The control unit 71 includes a display control section 72. The display control section 72 controls the display section 12. That is, the control section 60 controls the display section 12. The display control section 72 updates information displayed on the display section 12. By this, the image forming system 10 provides information to the user through the display section 12.

The control unit 71 includes an input receiving section 73. The input receiving section 73 receives input information input by the user through the input section 13. The input information includes an instruction by the user and the power supply information 65.

The control unit 71 includes a print control section 74. The print control section 74 controls the operation of the print head 15 to control the ejection of ink from the print head 15. For example, the print control section 74 controls the timing of printing, the amount of ink ejected from the print head 15, and the ejection position of the ink.

The print control section 74 may perform print on the medium 99 based on the read data acquired from the image reading device 25. That is, the image forming system 10 may have a copy function. The print control section 74 may perform printing on the medium 99 using image data acquired from a computer via a communication network or image data acquired from a storage medium that is attachable to and detachable from the image forming system 10.

The control unit 71 includes a transport control section 75. The transport control section 75 controls the medium transport section 16 to transport the medium 99 toward the print head 15. For example, the transport control section 75 causes the medium transport section 16 to transport the medium 99 by the operation of a motor that rotates a roller.

The control unit 71 may include an intermediate device control section 76. The intermediate device control section 76 controls the intermediate device 21. The intermediate device control section 76 controls the intermediate device 21 so that the medium 99 on which an image is formed is sent to the post-process device 22.

The control unit 71 may include a post- process control section 77. The post-process control section 77 causes the post-process device 22 to perform the post processing. Specifically, the post-process control section 77 causes the post-process device 22 to perform at least one of the alignment process, the staple process, the punch processing, and the shift process.

The control unit 71 may include a center folding control section 78. The center folding control section 78 causes the center folding device 23 to perform the center folding process. The center folding control section 78 may cause the center folding device 23 to perform the saddle stitching process.

The control unit 71 may include a large capacity sheet feed control section 79. The large capacity sheet feeding control section 79 controls the large capacity sheet feeding device 24 to supply the medium 99 from the large capacity sheet feeding device 24 to the medium transport section 16.

The control unit 71 may include a reading control section 80. The reading control section 80 controls the image reading device 25 to read the document as an image. The reading control section 80 acquires read data from the image reading device 25. The function of reading an image by the image reading device 25 is a scanning function.

The control unit 71 may include a network communication section 81. The network communication section 81 includes communication hardware according to a predetermined communication standard. The network communication section 81 communicates with an external device via a communication network.

The control unit 71 may include a network blocking section 82. The network blocking section 82 controls opening and closing of the network port switch 34.

The control unit 71 may include a FAX communication section 83. The FAX communication section 83 includes communication hardware for performing facsimile communication through a public line. The FAX communication section 83 transmits and receives the read data to and from another facsimile device via a public line.

The control unit 71 may include a FAX blocking section 84. The FAX blocking section 84 controls opening and closing of the FAX port switch 44.

The control unit 71 may include a power determination section 85. The power determination section 85 determines, based on the power supply information 65, whether or not the electric device can be operated. The power determination section 85 determines, based on the power supply information 65, whether or not each electric device can be operated by the power supply 52. Specifically, the power determination section 85 determines whether or not each of the electric devices such as the print head 15, the medium transport section 16, the intermediate device 21, the post-process device 22, the center folding device 23, the large capacity sheet feeding device 24, the image reading device 25, the network port 31, and the FAX port 41 can be operated by the power supply 52.

The control unit 71 includes a printable number calculation section 86. The printable number calculation section 86 calculates, based on the power supply information 65, the number of sheets of the medium 99 on which printing can be performed by the power supply 52.

### Print control

The control section 60 performs print control. The print control is control performed when the image forming system 10 is operated by the power supply 52. In the present embodiment, it is assumed that a print mode with the minimum power consumption, in other words, a print mode with the maximum printable number of sheets, is set as often as possible for the purpose of maintaining the print function. In the print mode with the minimum power consumption, the copy function, the scanning function, and the facsimile communication function are disabled.

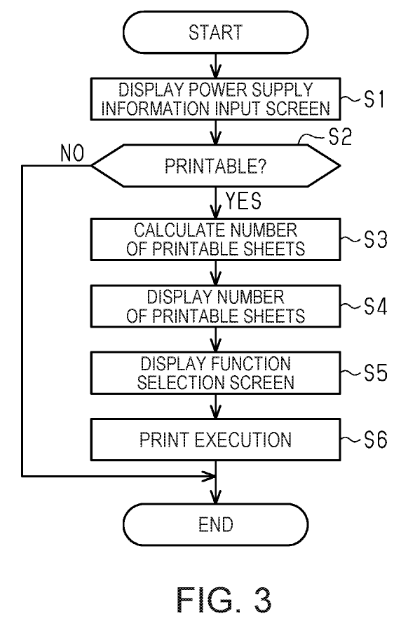

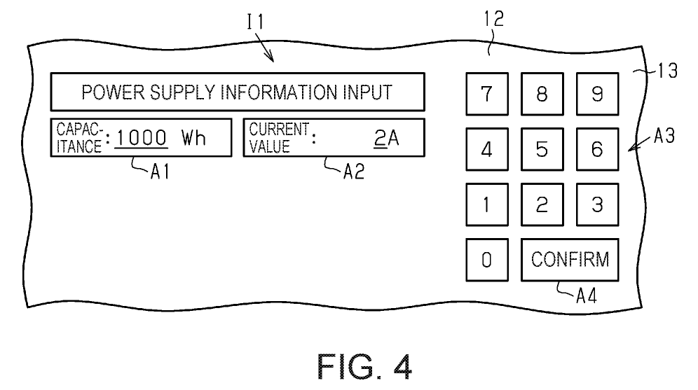

As illustrated in FIGS. 3 and 4, in step S1, the control section 60 causes the display section 12 to display a power source information input screen I1. The power source information input screen I1 is displayed on the display section 12, for example, by the user operating the input section 13.

The power source information input screen I1 includes, for example, a capacitance input section A1 and a current input section A2.

The capacitance input section A1 is a location for inputting the capacitance of the power supply 52. The current input section A2 is a location for inputting the maximum output current of the power supply 52.

The power source information input screen I1 includes a numeric input section A3 and a permitting section A4. The numeric input section A3 is a portion for inputting numerical values to the capacitance input section A1 and the current input section A2. The permitting section A4 is a section for permitting execution of printing.

The user selects a desired one of the capacitance input section A1 and the current input section A2, and then operates the numeric input section A3 to input a numeric value. The display device 56 of the power supply 52 displays the charging rate of the power supply 52. The user inputs a value obtained by multiplying the rated capacity of the power supply 52 by the charging rate to the capacitance input section A1. The capacitance input section A1 may include a rated capacity input section and a charging rate input section. In this case, the user may input the rated capacity of the power supply 52 to the rated capacitance input section and input the charging rate of the power supply 52 to the charging rate input section. In this case, the capacitance of the power supply 52 is calculated by the control section 60. The specifications of the power supply 52 such as the rated capacity of the power supply 52 and the maximum output current of the power supply 52, for example, can be grasped by checking the specification sheet of the power supply 52 or the label of the power supply 52. When the user inputs numerical values to the capacitance input section A1, the current input section A2, and the print sheet number input section A3, the control section 60 proceeds to step S2. In the example illustrated in FIG. 4, the capacitance of the power supply 52 is 1000 (Wh), and the maximum output current is 2 (A). The numerical values inputted to the capacitance input section A1 and the current input section A2 are stored in the memory 61 as the power supply information 65. Therefore, the input section 13 can receive input of the power supply information 65 from the user.

In step S2, the control section 60 determines whether or not printing can be performed. The control section 60 determines whether or not printing can be performed from the power supply information 65 input on the power source information input screen I1. For example, when the capacitance of the power supply 52 is smaller than the power value required for one process of the medium transport section 16 or the print head 15, printing cannot be performed. When the maximum output current of the power supply 52 is smaller than the current value required for one process of the medium transport section 16 or the print head 15, printing cannot be performed. In this manner, there are cases where, depending on the power supply 52, the medium transport section 16 or the print head 15 necessary for performing printing cannot be operated. When the determination result of step S2 is positive, that is, when printing can be performed, the control section 60 proceeds to step S3. When the determination result of step S2 is negative, that is, when printing cannot be performed, the control section 60 ends the print control. When the determination result of step S2 is negative, the control section 60 may display, on the display section 12, that printing is impossible. By performing the determination of step S2, the control section 60 functions as the power determination section 85.

In step S3, the control section 60 calculates the printable number of sheets. The control section 60 calculates the printable number of sheets from the capacitance of the power supply 52 inputted on the power source information input screen I1. The control section 60 calculates a power value required for the operation of the electric device necessary for outputting a single sheet of the medium 99. The power value required to output one sheet of the medium 99 is the sum of the power consumed, during output of one sheet of the medium 99, by the print head 15, the medium transport section 16, the intermediate device 21, the post process device 22, the center folding device 23, the large capacity sheet feeding device 24, the image reading device 25, the network port 31, and the FAX port 41. When the center folding process, the saddle stitching process, and the post processing are performed, output of the medium 99 means discharge from the image forming system 10 of the medium 99 after these processes are finished. When the center folding process, the saddle stitching process, and the post processing are not performed, output of the medium 99 means discharge from the image forming system 10 of the medium 99 on which an image is formed.

The control section 60 refers to the power table 63 to grasp the power consumed by each electric device. The control section 60 refers to the power table 63 to grasp the power consumed by the print head 15, the medium transport section 16, the intermediate device 21, the post process device 22, the center folding device 23, the large capacity sheet feeding device 24, the image reading device 25, the network port 31, and the FAX port 41.

The control section 60 recognizes, by referring to the power table 63, the power value corresponding to the print mode with the minimum power consumption. When there is an electric device that is not used, the power value required to output one sheet of the medium 99 is calculated by excluding the power value required for the operation of that electric device.

The control section 60 calculates how many sheets of the medium 99 can be output from the power value required to output one sheet of the medium 99 and the capacitance of the power supply 52. Then, the control section 60 sets the number of sheets of the medium 99 that can be output as the printable number of sheets. When the process of step S3 is completed, the control section 60 proceeds to step S4. By performing the process of step S3, the control section 60 functions as the printable number calculation section 86.

In step S4, the control section 60 causes the display section 12 to display the printable number of sheets. For example, the control section 60 causes the display section 12 to display a printable sheet number display screen.

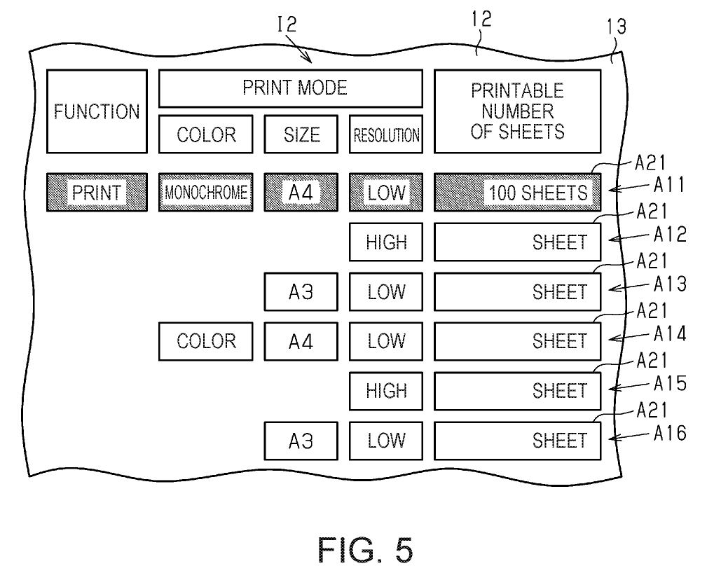

FIG. 5 illustrates an example of the printable sheet number display screen I2. The printable sheet number display screen I2 may be displayed on the display section 12 simultaneously with the power source information input screen I1. In the printable sheet number display screen I2 illustrated in FIG. 5, six print modes are displayed on the display section 12. Monochrome printing, with the size of the medium 99 in A4 size, and at low resolution, is set as a first print mode. Monochrome printing, with the size of the medium 99 in A4 size, and with high resolution, is set as a second print mode. Monochrome printing, with the size of the medium 99 in A3 size, and at a low resolution, is set as a third print mode. Color printing, with the size of the medium 99 in A4 size, and with low resolution, is set as a fourth print mode. Color printing, with the size of the medium 99 in A4 size, and with high resolution, is set as a fifth print mode. Color printing, with the size of the medium 99 in A3 size, and with low resolution, is set as a sixth print mode. The print mode with the lowest power consumption among the first to six print modes is the first print mode.

The printable sheet number display screen I2 includes a first mode display section A11 on which a display related to the first print mode is performed, a second mode display section A12 on which a display related to the second print mode is performed, and a third mode display section A13 on which a display related to the third print mode is performed. The printable sheet number display screen I2 includes a fourth mode display section A14 on which a display related to the fourth print mode is performed, a fifth mode display section A15 on which a display related to the fifth print mode is performed, and a sixth mode display section A16 on which a display related to the fifth print mode is performed.

The contents of the print modes corresponding to the mode display sections A11 to A16 are displayed on the mode display sections A11 to A16. For example, in the case of the first mode display section A11, the content of the first print mode corresponding to the first mode display section A11, that is, monochrome printing, the size of the medium 99 in A4 size, and printing at low resolution, is displayed.

Each of the mode display section A11 to A16 includes a printable number display section A21. The printable number display section A21 is a portion where the printable number of sheets in each print mode is displayed.

In the present embodiment, the printable number of sheets in the print mode with the minimum power consumption is calculated. Therefore, the printable number of sheets in the first print mode, which is the print mode with the lowest power consumption among the first to sixth print modes, is displayed. Therefore, the printable number of sheets is displayed on the printable number display section A21 of the first mode display section A11. The user can grasp the printable number of sheets in the print mode with the minimum power consumption from the number of printable sheet number display screen I2. For example, if the printable number of sheets calculated in step S3 is 100, then 100 is displayed on the printable number display section A21 of the first mode display section A11. When the process of step S4 is completed, the control section 60 proceeds to step S5.

In step S5, the control section 60 causes the display section 12 to display a function-selection screen for selecting whether to enable or disable the functions of the image forming system 10.

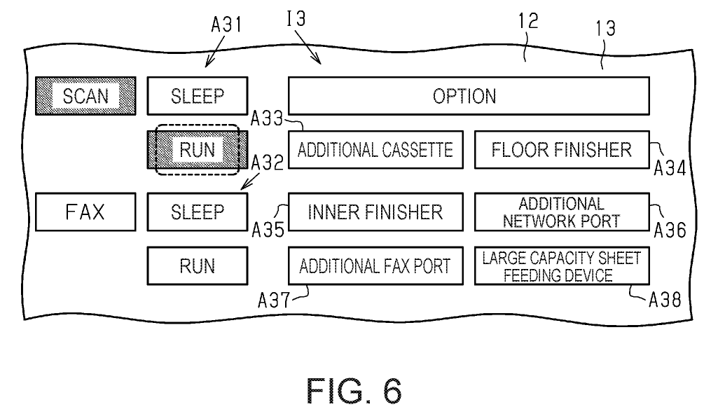

FIG. 6 illustrates an example of a function selection screen I3. The function-selection screen I3 may be displayed on the display section 12 simultaneously with the printable sheet number display screen I2 and the power source information input screen I1. The function-selection screen I3 may include standard function selection sections A31 and A32 corresponding to the standard functions, and option selection sections A33 to A38 corresponding to the options. A standard function is a function that is provided as a standard function in a multifunction peripheral including the image forming device 11 and the image reading device 25.

The standard function selection sections A31 and A32 include a first standard function selection section A31 corresponding to the scanning function and a second standard function selection section A32 corresponding to the facsimile communication function. The user can select whether to sleep or run the standard functions by operating the standard function selection sections A31 and A32. To sleep a function means to disable the function. Running a function means to make the function available. To sleep a function is an example of disabling a function. Running a function is an example of enabling the function. Running a function maintains the standard function in a usable state, and thus consumes more power than sleeping the function. The dashed line in the figure indicates operations by the user. As indicated by the dashed line in the figure, the background color of the selected item may be changed so that the user can recognize that the item is selected.

The option selection sections A33 to A38 include a first option selection section A33 corresponding to the additional cassette 14B, a second option selection section A34 corresponding to the floor finisher, and a third option selection section A35 corresponding to the inner finisher. The option selection sections A33 to A38 include a fourth option selection section A36 corresponding to the additional network port 33, a fifth option selection section A37 corresponding to the additional FAX port 43, and a sixth option selection section A38 corresponding to the large capacity sheet feeding device 24.

The user can activate an option by operating the option selection sections A33 to A38. The options that can be enabled may decrease according to options selected by the user. In the example illustrated in FIG. 6, there is a case where the capacitance of the power supply 52 is insufficient or the current exceeds the maximum output current by enabling the functions of both the additional FAX port 43 and the additional network port 33. In this case, when one of the additional FAX port 43 and the additional network port 33 is selected, the other may be made unselectable. At this time, the control section 60 may gray out the option selection sections A33 to A38 corresponding to the options that cannot be selected or may erase the option selection portions A33 to A38 from the display section 12.

The image forming system 10 may not include both the floor finisher and the inner finisher. Therefore, when one of the floor finisher and the inner finisher is selected, the other may be made unselectable.

The control section 60 may open the FAX port switch 44 when the function of the additional FAX port 43 is disabled by the function selection screen I3. When the function of the additional network port 33 is disabled by the option function selection screen I3, the control section 60 may open the network port switch 34.

When a function is enabled on the function selection screen I3, the control section 60 may update the printable number of sheets according to the enabled function. When a function is enabled, power consumption in the electric device increases. The control section 60 recognizes, by referring to the power table 63, the power value required for the operation of the electric device. Then, the control section 60 calculates a power value required to output one sheet of the medium 99. The control section 60 calculates the printable number of sheets from the capacitance of the power supply 52 and the power value required to output one sheet of the medium 99. The calculated printable number of sheets is presented to the user. For example, the printable number of sheets displayed on the printable sheet number display screen I2 is updated, and thus the presentation to the user is performed.

As described above, when the functions are enabled on the function-selection screen I3, the printable number of sheets when the functions are enabled is calculated. The printable number of sheets calculated in step S3 is the printable number of sheets when the functions selectable in the function selection screen I3 are disabled. Therefore, when the functions are enabled on the function selection screen I3, the printable number of sheets when the functions are enabled and the printable number of sheets in a case where the functions are disabled are calculated.

Therefore, when the floor finisher is enabled, the control section 60 calculates, based on the power value required for the operation of the post-process device 22, the printable number of sheets in a case where the function of the post-process device 22 is enabled and the printable number of sheets when the function of the post-process device 22 is disabled. The control section 60 calculates, based on the power value required for the operation of the large capacity sheet feeding device 24, the printable number of sheets in a case where the function of the large capacity sheet feeding device 24 is enabled and the printable number of sheets when the function of the large capacity sheet feeding device 24 is disabled.

When the user inputs the desired print sheet number to be printed and then printing is permitted, the control section 60 proceeds to step S6. The print sheet number to be printed is input by, for example, operating the numeric value input section A3. Printing is permitted by, for example, operating the permitting section A4.

In step S6, the control section 60 executes printing. When printing is completed, the control section 60 ends the print control.

### Update control

The control section 60 may perform an update control when the power supply information 65 is input from the power source information input screen I1. The update control is control for updating the printable number of sheets according to the number of sheets that have been printed. The update control may be control for updating the printable number of sheets in accordance with the power consumption of the power supply 52 with the lapse of time in addition to the number of sheets that have been printed. The power consumption of the power supply 52 over time includes at least one of self-discharge of the power supply 52 and standby power of the image forming system 10.

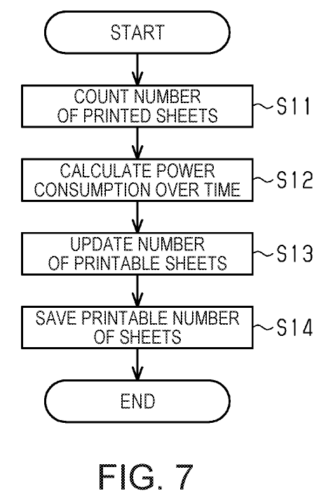

As illustrated in FIG. 7, in step S11, the control section 60 counts the number of sheets printed after the power supply information 65 is input. When the process of step S11 is completed, the control section 60 proceeds to step S12.

In step S12, the control section 60 calculates the power consumption of the power supply 52 accompanying the lapse of time. In one example, the power consumed by the power supply 52 per unit time is calculated in advance. Then, the control section 60 calculates the power consumption of the power supply 52 accompanying the lapse of time based on the elapsed time from the input of the power supply information 65 and the power consumed by the power supply 52 per unit time. When the process of step S12 is completed, the control section 60 proceeds to step S13.

In step S13, the control section 60 updates the printable number of sheets. The control section 60 may update the printable number of sheets by subtracting the number of sheets counted in step S11 from the printable number of sheets.

When the printable number of sheets is updated according to the power consumption of the power supply 52 accompanying the lapse of time, the control section 60 converts the power consumption calculated in step S12 into a print equivalence number. The print equivalence number is a numerical value indicating how many sheets of printing the power consumption of the power supply 52 accompanying the lapse of time corresponds to. That is, the print equivalence number is the number of sheets of the medium 99 that can be printed with the power consumption of the power supply 52 over time. The print equivalence number can be calculated based on the power consumption calculated in step S12 and the power value required to output one sheet of the medium 99.

The control section 60 may update the printable number of sheets by subtracting the number of sheets counted in step S11 and the print equivalence number from the printable number of sheets. When the process of step S13 is completed, the control section 60 proceeds to step S14.

In step S14, the control section 60 stores the printable number of sheets updated in step S13 in the memory 61. When the process of step S14 is completed, the control section 60 ends the update control.

The update control may be performed at a predetermined control cycle or may be performed each time the print control is executed.

When performing the update control, the control section 60 determines whether or not the printable number of sheets is stored in the memory 61 at the time of performing the print control. When the printable number of sheets is stored in the memory 61, the control section 60 may perform print control using the printable number of sheets stored in the memory 61.

The printable number of sheets stored in the memory 61 is erased when new power supply information 65 is input.

### Operation of first embodiment

When the image forming system 10 is operated by the power supplied from the power supply 52, the user inputs the power supply information 65 by operating the input section 13. The power supply information 65 includes at least information indicating the capacitance of the power supply 52. The control section 60 can calculate the printable number of sheets from the information indicating the capacitance of the power supply 52.

### Effects of first embodiment

(1-1) The control section 60 displays the printable number of sheets that can be printed by the power supply 52 on the display section 12. The user can grasp the printable number of sheets. Therefore, it is possible to suppress the power supply from the power supply 52 from being interrupted in the middle of printing.

(1-2) The control section 60 updates the printable number of sheets according to the number of sheets of the medium 99 on which printing was executed. When printing is executed, the capacitance of the power supply 52 decreases due to the power of the power supply 52 being consumed. Therefore, when the printable number of sheets is calculated from the capacitance of the power supply 52, it is necessary to input the power supply information 65 every time the image forming system 10 is used. In contrast, by updating the printable number of sheets according to the number of sheets of the medium 99 on which printing was executed, the control section 60 can recognize the printable number of sheets even when new power supply information 65 is not input.

(1-3) The image forming system 10 includes the input section 13. Therefore, the user can input the power supply information 65 by operating the input section 13.

(1-4) The control section 60 calculates the printable number of sheets in a case where the function of the post-process device 22 is enabled and the printable number of sheets when the function of the post-process device 22 is disabled. Then, the control section 60 can cause the display section 12 to display the printable number of sheets in a case where the function of the post-process device 22 is enabled and the printable number of sheets in a case where the function of the post-process device 22 is disabled. Therefore, the user can grasp the printable number of sheets in a case where the function of the post-process device 22 is enabled and the printable number of sheets when the function of the post-process device 22 is disabled.

(1-5) The control section 60 calculates the printable number of sheets in a case where the function of the large capacity sheet feeding device 24 is enabled and the printable number of sheets in a case where the function of the large capacity sheet feeding device 24 is disabled. Then, the control section 60 can display, on the display section 12, the printable number of sheets in a case where the function of the large capacity sheet feeding device 24 is enabled and the printable number of sheets in a case where the function of the large capacity sheet feeding device 24 is disabled. Therefore, the user can grasp the printable number of sheets in a case where the function of the large capacity sheet feeding device 24 is enabled and the printable number of sheets in a case where the function of the large capacity sheet feeding device 24 is disabled.

### Second Embodiment

A second embodiment of the image forming system will be described. The image forming system of the second embodiment is different from that of the first embodiment in the print control. In the second embodiment, a print mode is selected by a user from a plurality of print modes. Hereinafter, the print control of the second embodiment will be described.

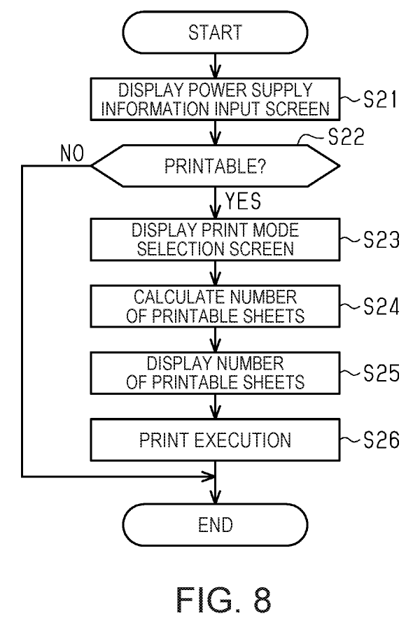

As illustrated in FIG. 8, in step S21, the control section 60 causes the power source information input screen I1 to be displayed on the display section 12. The power source information input screen I1 displayed in step S21 is, for example, the same as that in the first embodiment When the process of step S21 is completed, the control section 60 proceeds to step S22.

In step S22, the control section 60 determines whether or not printing can be performed. The determination of step S22 is the same determination as step S2. When the determination result of step S22 is negative, the control section 60 ends the print control. When the determination result of step S22 is positive, the control section 60 proceeds to step S23.

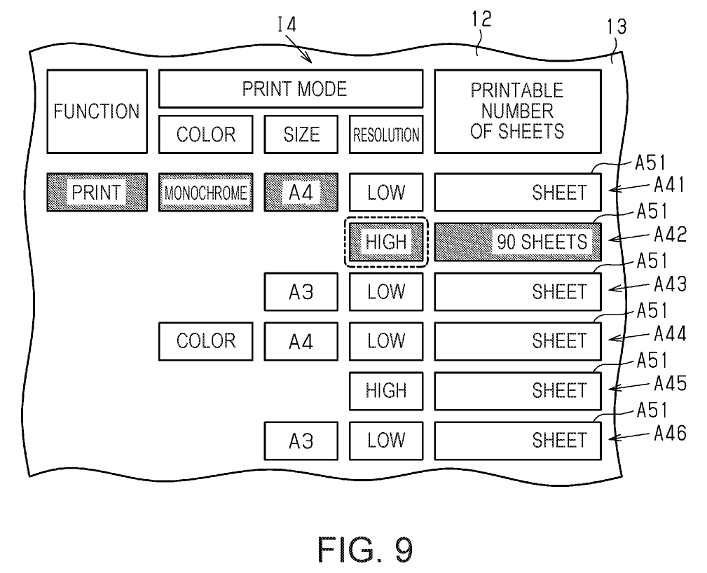

As illustrated in FIGS. 8 and 9, in step S23, the control section 60 causes the display section 12 to display a print mode selection screen I4. The print mode selection screen I4 may be displayed on the display section 12 simultaneously with the power source information input screen I1. The print mode selection screen I4 includes a first mode selection section A41 for selecting the first print mode, a second mode selection section A42 for selecting the second print mode, and a third mode selection section A43 for selecting the third print mode. The print mode selection screen I4 includes a fourth mode selection section A44 for selecting the fourth print mode, a fifth mode selection section A45 for selecting the fifth print mode, and a sixth mode selection section A46 for selecting the sixth print mode.

Each of the mode selection sections A41 to A46 includes a printable sheet number display section A51. The printable sheet number display section A51 is a portion where the printable number of sheets in each print mode is displayed.

The user selects any one of the first mode selection section A41 to the sixth mode selection section A46, thereby selecting the print mode corresponding to the mode selection sections A41 to A46. In the example illustrated in FIG. 9, the second print mode is selected by operating the second mode selection section A42. As indicated by the dashed line in the figure, the mode selection sections A41 to A46 corresponding to the selected print mode may be configured to allow the user to recognize that they are selected by changing the background color. When the process of step S23 is completed, the control section 60 proceeds to step S24.

In step S24, the control section 60 calculates the printable number of sheets. The control section 60 calculates, by referring to the power table 63, the printable number of sheets in the print mode selected in step S23. Specifically, the control section 60 calculates, by referring to the power table 63, the power value required to output one sheet of the medium 99 in the print mode selected in step S23. Then, the control section 60 calculates the printable number of sheets from the capacitance of the power supply 52 and the power value required to output one sheet of the medium 99. When the process of step S24 is completed, the control section 60 proceeds to step S25.

In step S25, the control section 60 causes the display section 12 to display the printable number of sheets. For example, the control section 60 displays the printable number of sheets calculated in step S23 on the printable sheet number display section A51 of the mode selection sections A41 to A46 operated in step S24. In the example illustrated in FIG. 9, 90 sheets are displayed in the printable sheet number display section A51 of the second mode selection section A42.

As in the first embodiment, the control section 60 may cause the display section 12 to display the function selection screen I3 on which the user can select whether to enable or disable the functions of the image forming system 10. In this case, the numerical values displayed in the printable sheet number display section A51 of the mode selection sections A41 to A46 change according to the functions enabled in the function-selection screen I3.

When the user inputs the desired number of sheets to be printed and then the printing is permitted, the control section 60 proceeds to step S26.

In step S26, the control section 60 executes printing in the selected print mode. When printing is completed, the control section 60 ends the print control.

### Effects of second embodiment

According to the second embodiment, the following effects can be obtained in addition to the effects of the first embodiment.

(2-1) The control section 60 calculates the printable number of sheets of the print mode selected by the user among the plurality of print modes. This enables the user to grasp the printable number of sheets in the selected print mode.

### Third Embodiment

A third embodiment of the image forming system will be described. The image forming system of the third embodiment is different from that of the first embodiment in the print control. Hereinafter, the print control of the third embodiment will be described.

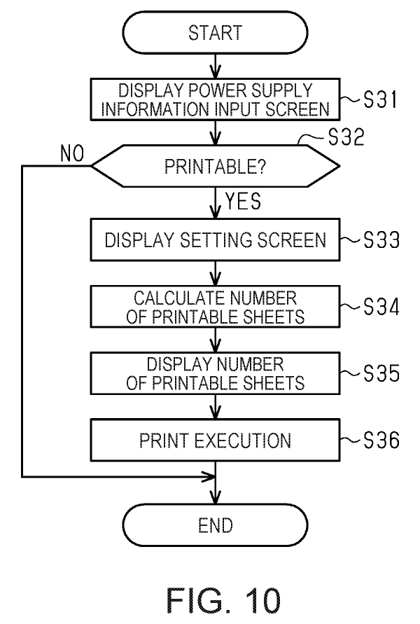

As illustrated in FIG. 10, in step S31, the control section 60 causes the power source information input screen I1 to be displayed on the display section 12. The power source information input screen I1 displayed in step S31 is, for example, the same as that in the first embodiment. When the process of step S31 is completed, the control section 60 proceeds to step S32.

In step S32, the control section 60 determines whether or not printing can be performed. The determination of step S32 is the same determination as step S2. When the determination result of step S32 is negative, the control section 60 ends the print control. When the determination result of step S32 is positive, the control section 60 proceeds to step S33.

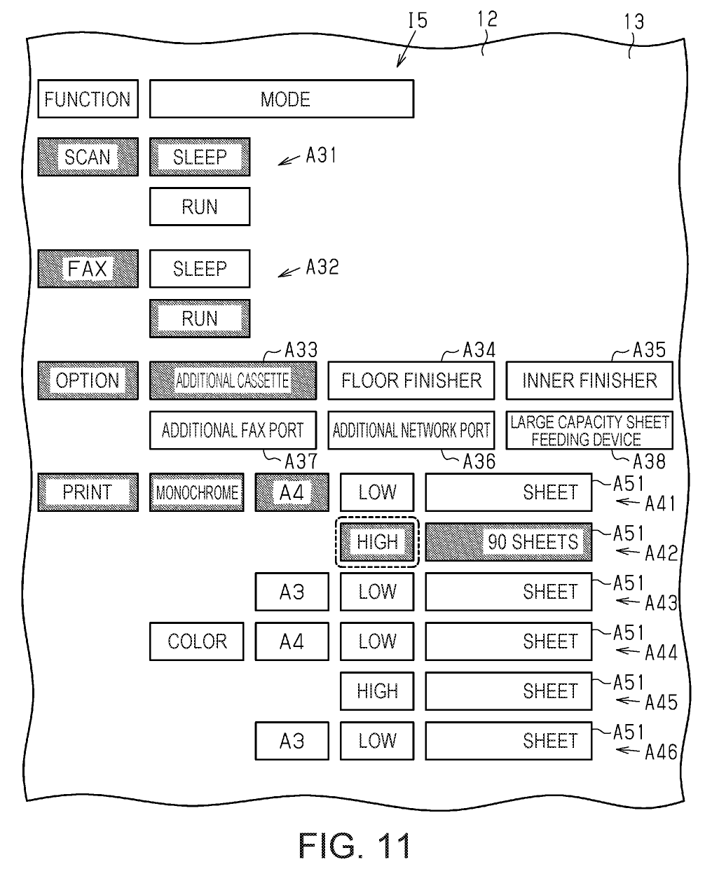

As illustrated in FIGS. 10 and 11, in step S33, the control section 60 causes the display section 12 to display a setting screen I5. The setting screen I5 may be displayed on the display section 12 simultaneously with the power source information input screen I1. The setting screen I5 includes the standard function selection sections A31 and A32, the option selection sections A33 to A38, and the mode selection sections A41 to A46. The standard function selection sections A31 and A32 and the option selection sections A33 to A38 are the same as those in the first embodiment. The mode selection sections A41 to A46 are the same as those in the second embodiment.

The user selects functions to be enabled by operating the standard function selection sections A31 and A32 and the option selection sections A33 to A38. The user selects a print mode by operating the mode selection sections A41 to A46. By this, the printable number of sheets in the selected print mode, which is the printable number of sheets when the selected function is enabled, is displayed in the printable sheet number display section A51.

In the present embodiment, the selection of the function to be enabled is prioritized between the selection of the function to be enabled and the selection of the print mode. Then, the selectable print modes are limited in accordance with the selection of the function to be enabled. Therefore, in order to select the functions to be enabled first, in the setting screen I5, the standard function selection sections A31 and A32 and the option selection sections A33 to A38 are displayed above the mode selection sections A41 to A46.

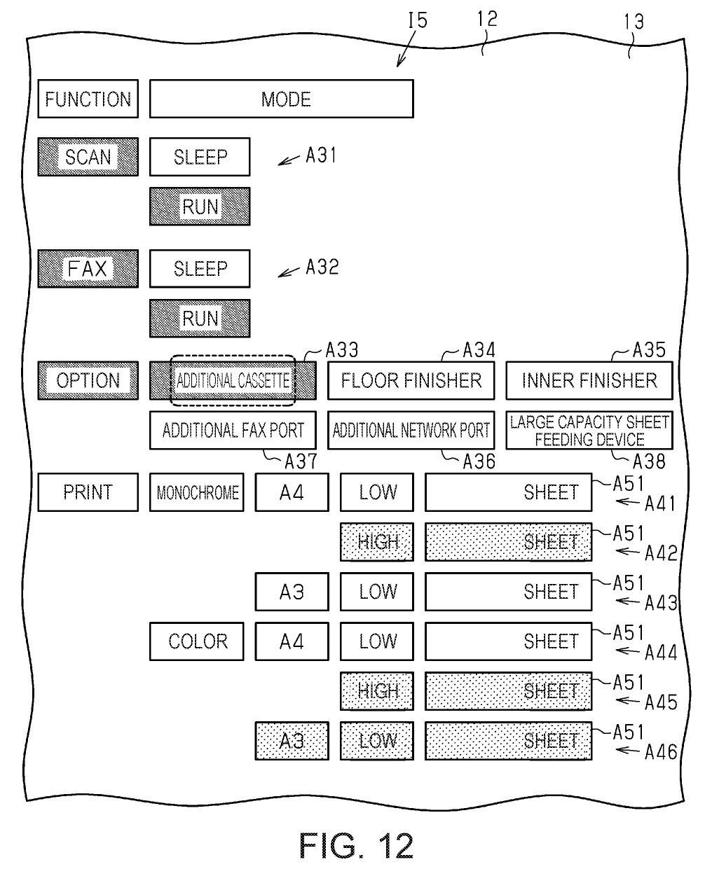

As illustrated in FIG. 12, when the scanning and facsimile communication functions are running and the additional cassette 14B function is enabled, the second, fifth, and sixth print modes are disabled. For example, in a combination of these functions and these print modes, there is a case where the capacitance of the power supply 52 is insufficient or the current value required to output one sheet of the medium 99 exceeds the maximum output current. In this case, the control section 60 disables selection of the second print mode, the fifth print mode, and the sixth print mode. For example, the control section 60 deletes the mode selection sections A42, A45, and A46 corresponding to the second, fifth, and the sixth print mode from the setting screen I5 or grays them out.

In this manner, the control section 60 limits the print mode according to the selection of the function to be enabled.

Therefore, when the floor finisher is enabled, if there is a print mode in which the capacitance of the power supply 52 is insufficient or the maximum output current of the power supply 52 is insufficient, the control section 60 disables the selection of the print mode. That is, the control section 60 limits, based on the power value required for the operation of the post-process device 22, the print mode that can be selected when the function of the post-process device 22 is enabled. When the function of the large capacity sheet feeding device 24 is enabled, if there is a print mode in which the capacitance of the power supply 52 is insufficient or the maximum output current of the power supply 52 is insufficient, the control section 60 disables the print mode from being selected. That is, the control section 60 limits, based on the power value required for the operation of the large capacity sheet feeding device 24, the print modes that can be selected when the function of the large capacity sheet feeding device 24 is enabled.

When the function to be enabled and the print mode are selected on the setting screen I5, the control section 60 proceeds to step S34.

In step S34, the control section 60 refers to the power table 63 to calculate the printable number of sheets in the function selected to be enabled in the setting screen I5 and the selected print mode. When the process of step S34 is completed, the control section 60 proceeds to step S35.

In step S35, the control section 60 causes the display section 12 to display the printable number of sheets calculated in step S34. For example, the control section 60 causes the printable sheet number display A51 of the mode selection sections A41 to A46 operated in step S33 to display the printable number of sheets calculated in step S34.

When the user inputs the desired number of sheets to be printed and then printing is permitted, the control section 60 proceeds to step S36.

In step S36, the control section 60 executes printing.

When printing is completed, the control section 60 ends the print control.

### Effects of third embodiment

According to the third embodiment, the following effects can be obtained in addition to the effects of the first embodiment.

(3-1) The control section 60 limits, based on the power value required for the operation of the post-process device 22, the print modes that can be selected when the function of the post-process device 22 is enabled. The user can easily grasp the selectable print modes.

(3-2) The control section 60 limits, based on the power value required for the operation of the large capacity sheet feeding device 24, the print mode that can be selected when the function of the large capacity sheet feeding device 24 is enabled. The user can easily grasp the selectable print modes.

### Modifications

The embodiments may be modified as follows: The embodiments and the following modifications can be implemented in combination with each other within a range where no technical contradiction occurs.

In the third embodiment, the control section 60 may prioritize the selection of the print mode and limit the functions that can be enabled according to the selected print mode.

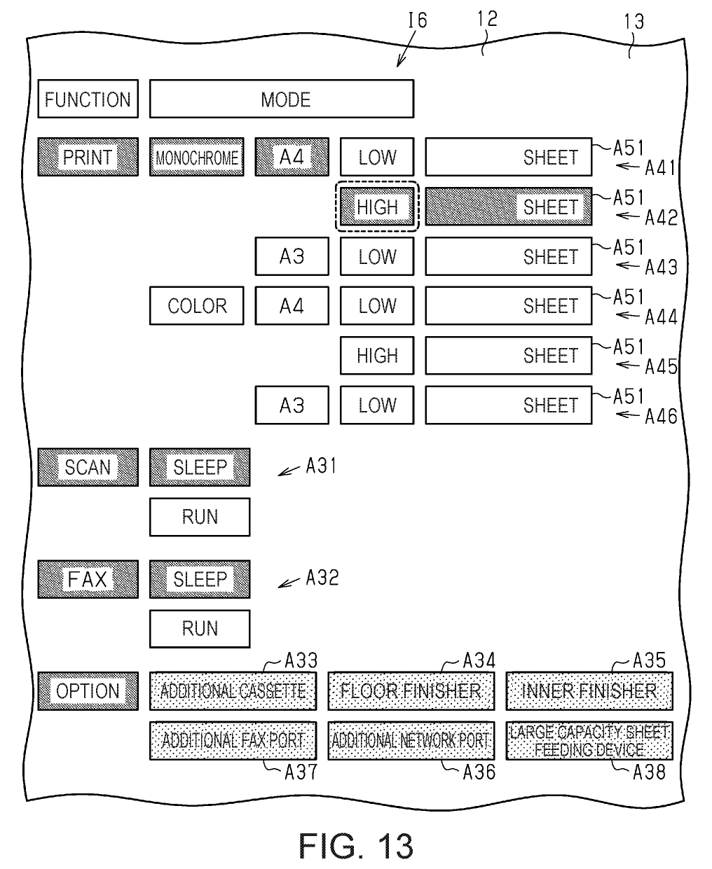

As illustrated in FIG. 13, in a setting screen I6 displayed on the display section 12 in step S33, the mode selection sections A41 to A46 are displayed above the standard function selection sections A31 and A32 and the option selection sections A33 to A38.

This prompts the user to select the print mode before selecting the function to be enabled.

When the print mode is selected by the operation of the mode selection sections A41 to A46, the control section 60 limits the functions that can be enabled. For example, in a case where the capacitance of the power supply 52 is insufficient or the current value required to output one sheet of the medium 99 exceeds the maximum output current in the combination of the selected print mode and function, the control section 60 makes the function not selectable.

In the example illustrated in FIG. 13, the second print mode is selected by operation of the second mode selection section A42 and, by this, it is no longer possible to select functions in which the capacitance of the power supply 52 or the maximum output current is insufficient in combination with the second print mode. In particular, sleep is selected for the standard function selection sections A31 and A32, and the option selection sections A33 to A38 are grayed out or erased from the setting screen I6.

Therefore, the control section 60 restricts the function of the post-process device 22 based on the print mode selected by the user and the power value required for the operation of the post-process device 22. Specifically, when the post-process device 22 cannot be operated in the print mode selected by the user, the control section 60 restricts the function of the post-process device 22 based on the power value required for the operation of the post-process device 22. That is, the function of the post-process device 22 is disabled. According to this, it is possible to suppress the function of the post-process device 22 from being enabled even though the post-process device 22 cannot be operated.

In each embodiment, the option that enables or disables the function may include the center folding device 23. In this case, the processing section includes at least one of the post-process device 22 and the center folding device 23.

In each embodiment, the image forming system 10 may include a wireless communication device wirelessly connected to a communication network, instead of or in addition to the network port 31.

In each embodiment, the image forming system 10 may include at least the image forming device 11.

In each embodiment, the power supply information 65 may be acquired by communication between the control section 60 and the power supply 52. For example, the image forming system 10 and the power supply 52 may include a communication section configured to communicate with each other, and the control section 60 may acquire the power supply information 65 from the battery management system 55 through communication by the communication section. The communication may be wire communication or wireless communication.

Definitions: As used herein, the expression "at least one" means "one or more" of the desired options. As an example, the expression "at least one" used in the present specification means "only one option" or "both of two options" when the number of options is two. As another example, the expression "at least one" used in the present specification means "only one option" or "a combination of two or more arbitrary options" when the number of options is three or more.

### Technical ideas

Hereinafter, technical ideas and effects thereof grasped from the above-described embodiment and modifications will be described.

(A) An image forming system that operates by power supplied from power supply and that includes a print head configured to print on a medium; a medium transport section configured to transport the medium toward the print head; a display section configured to display information related to printing; a control section configured to control the display section, wherein the control section calculates a printable number of sheets of the medium that are printable by the print head based on power supply information, which is information of the power supply and which includes at least information indicating capacitance of the power supply and displays, on the display section, the printable number of sheets.

According to this configuration, the user can grasp the printable number of sheets for each print mode.

(B) The image forming system according to (A), wherein the control section updates the printable number of sheets according to a number of sheets of the medium that were printed.

According to this configuration, by updating the printable number of sheets based on the number of sheets of printed medium, the control section can recognize the printable number of sheets even when new power supply information is not input.

(C) The image forming system according to (A) or (B), further including an input section configured to receive input of the power supply information.

According to this configuration, the user can input the power supply information.

(D) The image forming system according to any one of (A) to (C), further including a processing section configured to perform processing on the medium on which printing was performed, wherein the control section is configured to calculate, based on a power value required for operation of the processing section, the printable number of sheets for when a function of the processing section is enabled and the printable number of sheets for when the function of the processing section is disabled.

According to this configuration, the user can grasp the printable number of sheets in a case where the function of the processing section is enabled and the printable number of sheets when the function of the processing section is disabled.

(E) The image forming system according to any one of (A) to (D), further including a plurality of print modes, wherein among the plurality of the print modes, the control section calculates the printable number of sheets in a print mode selected by a user.

According to this configuration, the user can grasp the printable number of sheets in the selected print mode.

(F) The image forming system according to (E), further including a processing section configured to perform processing on the medium on which printing was performed, wherein the control section limits, based on a power value required for operation of the processing section, the print mode selectable when the function of the processing section is enabled.

According to this configuration, the user can easily grasp the selectable print mode.

(G) The image forming system according to (E), further including a processing section configured to perform processing on the medium on which printing was performed, wherein the control section limits a function of the processing section based on the print mode selected by the user and on a power value required for operation of the processing section.

According to this configuration, it is possible to suppress the function of the processing section from being enabled even though the processing section cannot be operated.

(H) The image forming system according to any one of (A) to (G), further including a medium supply device that supplies the medium to the medium transport section, wherein the control section calculates, based on a power value required for operation of the medium supply device, the printable number of sheets for when a function of the medium supply device is enabled and the printable number of sheets for when the function of the medium supply device is disabled.

According to this configuration, the user can grasp the printable number of sheets in a case where the function of the medium supply device is enabled and the printable number of sheets when the function of the medium supply device is disabled.

What is claimed is:

1. An image forming system that operates by power supplied from a power supply, the image forming system comprising:
a print head configured to print on a medium;
medium transport section configured to transport the medium toward the print head;
a display section configured to display information related to printing;
a control section configured to control the display section, wherein
the control section
calculates a printable number of sheets of the medium that are printable by the print head based on power supply information, which is information of the power supply and which includes at least information indicating capacitance of the power supply and
displays, on the display section, the printable number of sheets.

2. The image forming system according to claim 1, wherein
the control section updates the printable number of sheets according to a number of sheets of the medium that were printed.

3. The image forming system according to claim 1, further comprising:
an input section configured to receive input of the power supply information.

4. The image forming system according to claim 1, further comprising:
a processing section configured to perform processing on the medium on which printing was performed, wherein
the control section is configured to calculate, based on a power value required for operation of the processing section, the printable number of sheets for when a function of the processing section is enabled and the printable number of sheets for when the function of the processing section is disabled.

5. The image forming system according to claim 1, further comprising:
a plurality of print modes, wherein
among the plurality of the print modes, the control section calculates the printable number of sheets in a print mode selected by a user.

6. The image forming system according to claim 5, further comprising:
a processing section configured to perform processing on the medium on which printing was performed, wherein
the control section limits, based on a power value required for operation of the processing section, the print mode selectable when the function of the processing section is enabled.

7. The image forming system according to claim 5, further comprising:
a processing section configured to perform processing on the medium on which printing was performed, wherein
the control section limits a function of the processing section based on the print mode selected by the user and on a power value required for operation of the processing section.

8. The image forming system according to claim 1, further comprising:
a medium supply device that supplies the medium to the medium transport section, wherein
the control section calculates, based on a power value required for operation of the medium supply device, the printable number of sheets for when a function of the medium supply device is enabled and the printable number of sheets for when the function of the medium supply device is disabled.

9. A control method of an image forming system operated by power supplied from a power supply, the image forming system including
a print head configured to perform printing on a medium and a display section configured to display information related to printing, the control method comprising:
acquiring power supply information including information that indicates a capacitance of the power supply;
calculating, based on the power supply information, a printable number of sheets, which is a number of sheets of the medium on which printing by the print head is possible; and
displaying, on the display section, the printable number of sheets.
